(19) United States
(12) Patent Application Publication
(10) Pub. No.: US 2008/0032082 A1
(43) Pub. Date: Feb. 7, 2008

(54) Paint-masking tool and kit

(76) Inventors: Ivo Scur, Westville, IN (US); Sherry A. Scur, Westville, IN (US)

Correspondence Address: Charles F. Meroni, Jr., P.O. Box 309, Barrington, IL, 60011, US

(21) Appl. No.: 11/500,042

(22) Filed: Aug. 7, 2006

(51) Int. Cl. B32B 33/00

(52) U.S. Cl. 428/40.1

(57) ABSTRACT

A paint masking tool and kit comprising the same comprises a floor-masking surface, a floor-engaging surface, and an inner molding-engaging edge. The inner molding-engaging edge comprises a transverse, negatively-contoured molding profile complementarily alignable adjacent a transverse positively-contoured molding profile of doorway molding. When the inner molding-engaging edge is complementarily aligned adjacent the molding element, and the floor-engaging surface engages a floor surface, the floor-masking surface functions to mask the floor surface adjacent the doorway periphery from material such as paint or stain applied to molding elements laterally donning a doorway.

### BACKGROUND OF THE INVENTION

1. Field of the Invention

The present invention generally relates to a tool for masking protectable surfaces from matter being applied to adjacent structure. More particularly, the present invention relates to a paint-masking tool and kit configured for complementary alignment adjacent doorway molding and the like to protect underlying floor surfaces.

2. Description of the Prior Art

Paint masking tools and tapes are known in the art. Bearing this notion in mind, and with a view to the prior art, it will be seen that a number of attempts have been made to develop innovative apparatuses or devices to aid the painter or craftsman mask certain surfaces from materials being applied in adjacency thereto. Some of the more pertinent prior art relating to paint masking tools and the like is described hereinafter.

U.S. Pat. No. 1,411,462 ('462 patent), which issued to Wendt, discloses a Wall Protector or Shield. The '462 patent teaches a protective shield, comprising an elongated sheet metal member formed with a spring portion terminating in a straight edge and a supporting flange spaced apart from said spring portion, said flange having a finger opening.

U.S. Pat. No. 2,290,472 ('472 patent), which issued to Hendrick, discloses a Painter's Masking Shield. The '472 patent teaches a painter's masking shield, comprising a body having edge formations at relatively different angles, vacuum cups for connecting the body, a stem projecting from the vacuum cups and extending through a relatively enlarged opening in the body, the body having a flaring raised portion surrounding the opening to permit substantially universal movement of the stem with respect to the body, and spring pressure means for forcing the body toward the cups.

U.S. Pat. No. 3,565,038 ('038 patent), which issued to Van Barriger, discloses a Paint Masking Tool. the '038 patent teaches a tool for masking a molding while painting the associated wall portion having two or more interfitting panels adapted to be slid towards or away from each other to selectively vary the total length of the tool in order to mask different lengths of the molding. Each panel consisting of a one piece, elongated structure with two flange portions extending transversely away from the opposite edges of its rectangular center section. One flange being adapted to rest on the top of the molding and the other flange section being adapted to rest on the floor. To receive and hold two of the panels together in an interfitting relationship, the lower flange portion includes a semienclosed trackway along its length which receives in a telescopic manner a similar smaller semienclosed trackway of the other panel.

U.S. Pat. No. 4,398,495 ('495 patent) which issued to Harris Jr. et al., discloses a Paint Shield. The '495 patent teaches a paint shield comprising a thin rectangular sheet with a longitudinal crease extending in from one end terminating short of the opposite end. A transverse crease is provided which intercepts the longitudinal crease. The arrangement is such that a portion of the shield can be bent about the transverse crease to protect areas intersecting at an angle from paint, such as corner molding and the like. By flexing the shield about its longitudinal crease, the bent portion automatically snaps back into a coplanar relationship with the remaining portion of the sheet so that its maximum longitudinal length is again available for shielding while painting. Notches can be cut out from opposite ends dimensioned to snugly engage 2.times.4 inch rafters or 2.times.6 inch rafters to protect surrounding wall areas when painting the rafters.

U.S. Pat. No. 6,315,831 ('831 patent), which issued to Renetta, discloses a Paint Guard for Use with Trim and Molding. The '831 patent teaches a guard that may be attached to molding or trim during painting operations to prevent paint from dripping or splashing from a surface to be painted one color onto a surface to be painted a different color or which will remain unpainted. In its primary embodiment, the present invention provides an elongated strip of material, preferably plastic, having a cross-sectional shape consisting of a terminal first end which extends around in a generally U-shaped hook pattern, a relatively straight central section integrally extending from the non-terminal end of the hook section, and a curved section that extends along a predetermined radius and terminates with a relatively straight portion that extends essentially perpendicularly to the central section.

U.S. Pat. No. 6,358,321 ('321 patent), which issued to Meyer et al., discloses a Corner Paint Shield. The '321 patent teaches a corner paint shield apparatus having at least one arm including at least one groove for collecting excess paint and an outer lip for preventing paint from seeping from the painted surface to one not intended to receive paint. The shield further includes a member attached to the arm for moving the paint shield to and from a desired position.

From a review of these publications and other prior paint masking tool configured for complementary alignment with the undulating transverse profile of doorway molding or similar other structures wherein there is a desire to mask adjacent surfaces. The prior art thus perceives a need for a paint masking tool configured for complementary alignment with the transverse profile (whether undulating or smooth) of doorway molding and the like.

### SUMMARY OF THE INVENTION

Accordingly, it is an object of the present invention to provide a each masking tool and/or masking tool kit comprising the same wherein each masking tool comprises a first or top, floor-masking surface, a second or bottom, floor-engaging surface, an inner molding-engaging edge, and a plurality of outer free edges. The inner molding-engaging edges each comprise a transverse, negatively-contoured molding profile complementarily alignable adjacent a transverse positively-contoured molding profile of (doorway) molding. When the inner molding-engaging edges are complementarily aligned adjacent the molding elements, and the floor-engaging surfaces engage a floor surface, the floor-masking surfaces function to mask the floor surface adjacent the doorway periphery from material such as paint or stain applied to molding elements laterally donning a doorway.

Other objects of the present invention, as well as particular features, elements, and advantages thereof, will be elucidated or become apparent from, the following description and the accompanying drawing figures.

### BRIEF DESCRIPTION OF THE DRAWINGS

Other features of our invention will become more evident from a consideration of the following brief description of patent drawings:

FIG. 1 is a fragmentary perspective type depiction of a molding-laden doorway depicting contour-reversed, paired masking tool being complementarily aligned with the transverse profile of the laterally-opposing doorway molding.

FIG. 2 is a fragmentary perspective type depiction of an inferior portion of the right-most doorway molding shown in FIG. 1 and further depicting paint-spraying means applying paint to the doorway molding, and a masking tool masking a floor surface inferiorly adjacent the doorway molding from the applied paint.

FIG. 3 is a complex depiction showing a masking tool kit in exploded perspective, a packaged masking tool kit, and a component masking tool with peel-away adhesive-covering backing in partially removed state.

FIG. 4(a) is a top perspective view of a masking tool of the present invention.

FIG. 4(b) is an enlarged fragmentary top perspective view of one end of the masking tool shown in FIG. 4(a).

FIG. 4(c) is a fragmentary perspective type depiction of a user manually removing the masking tool from a floor surface.

FIG. 5 is a top plan type depiction of left and right transverse cross-sections of doorway molding (upper portions) and top plan views of left and right masking tools (lower portions) being complementarily aligned with the doorway molding.

FIG. 6 is a top plan type depiction of left and right transverse cross-sections of doorway molding (upper portions) and top plan views of left and right masking tools (lower portions) in complementary alignment with the doorway molding.

### DETAILED DESCRIPTION OF THE PREFERRED EMBODIMENT(S)

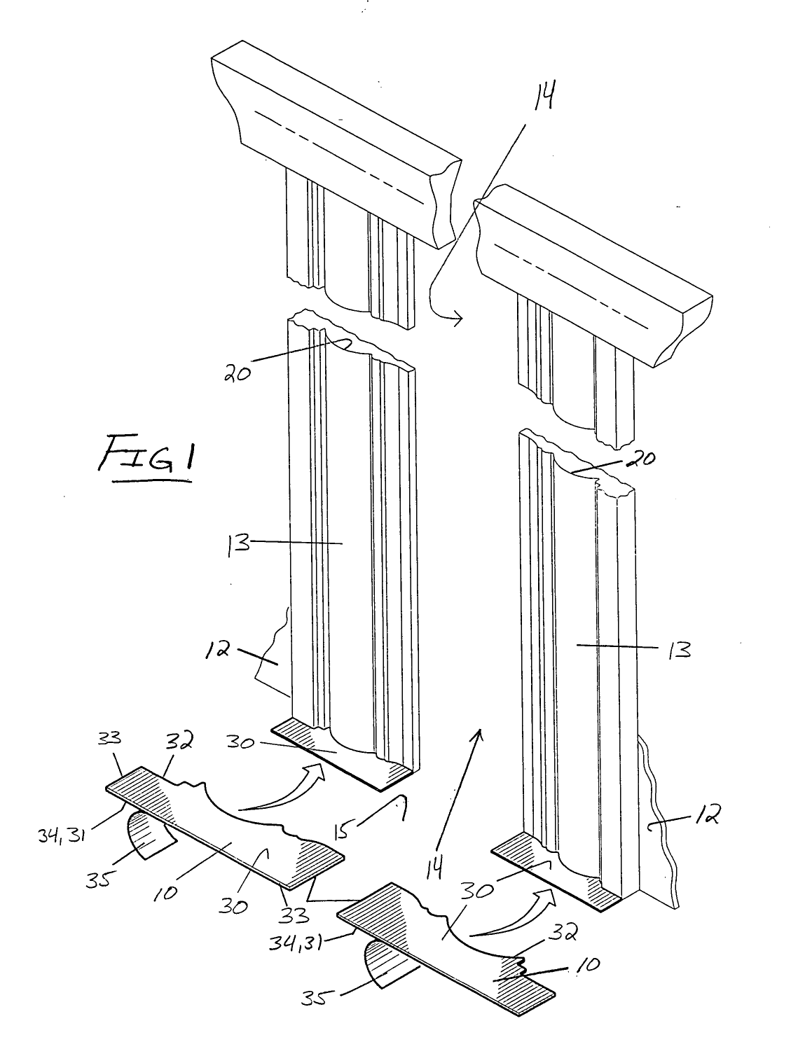

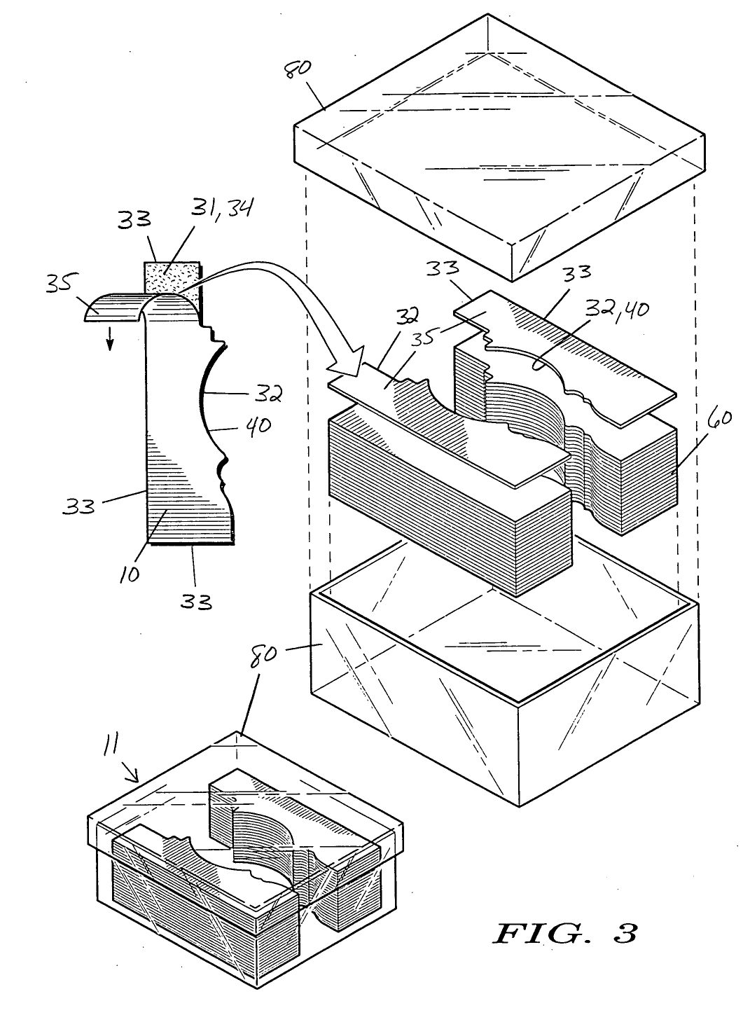

Referring now to the drawings, the preferred embodiment of the present invention generally concerns a masking tool 10 as generally illustrated and referenced in FIGS. 1-6; and/or a masking tool kit 11 as generally illustrated and referenced in FIG. 3. It is contemplated that the masking tool 10 or masking tool kit 11 of the present invention further enables a certain broad-based doorway-masking system as generally illustrated and referenced in FIG. 1. In this last regard, it is contemplated that the doorway-masking system, taught or enabled by the present invention, functions to essentially mask a doorway periphery 12 as fragmentarily shown and referenced in FIG. 1.

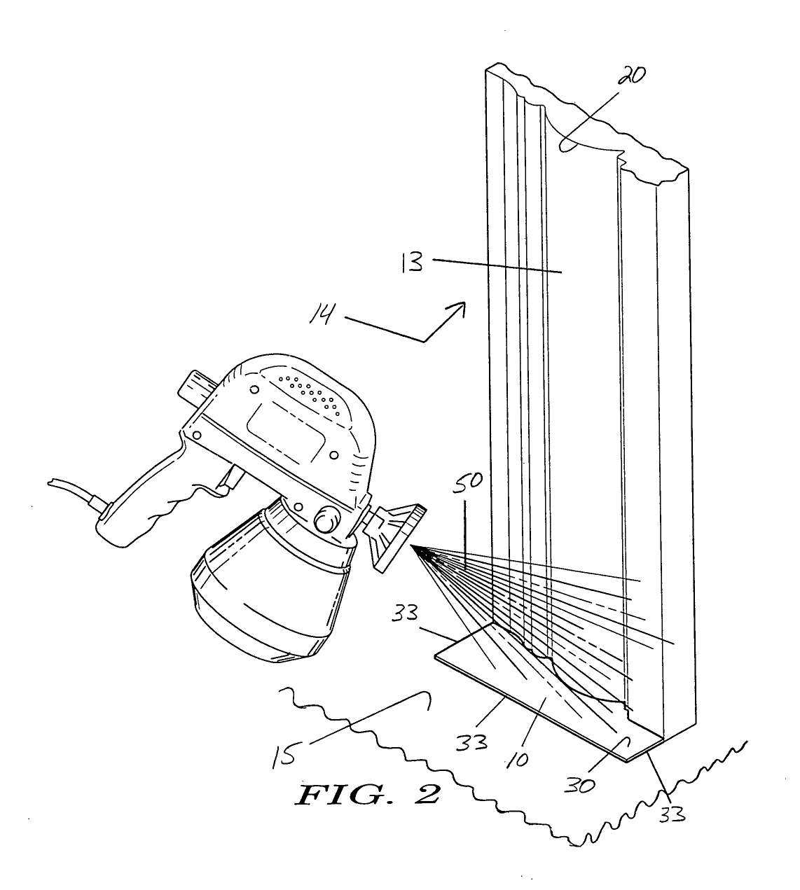

The doorway-masking system of the present invention may be said to preferably comprise, in combination, a pair of doorway molding elements 13 as generally illustrated and referenced in FIGS. 1 and 2; and a pair of masking tools 10 as previously referenced. It will be seen from an inspection of the noted figures that the molding elements 13 are preferably laterally-aligned adjacent a doorway 14 in superior adjacency to a floor surface 15. Central to the practice of the present invention, it should be noted that each molding element 13 inherently or essentially comprises a transverse, positively-contoured ornamental or decorative molding profile 20 as generally referenced in FIGS. 1, 2, 5, and 6.

In this last regard, it is noted that door molding and the like provides door peripheries and the like with a certain decorative or ornamental finished appearance. Oftentimes, the molding or similar other target structure is painted, stained, or otherwise applied with some sort of topical agent. Given, the non-uniform transverse profile of certain molding elements, it is often difficult to properly mask the surfaces parallel to or adjacent with the transverse molding profile 20 such as floor surface 15. The masking tool 10 of the present invention functions to complement the transverse molding profile 20 so as to properly mask the underlying surface such as floor surface 15.

In this regard, it will be seen that each masking tool 10 of the present invention preferably comprising a first, top, or superior floor-masking surface 30 as referenced in FIGS. 1, 2, and 4(a)-4(c); a second or bottom, floor-engaging surface 31 or surface-engaging portion as referenced in FIGS. 1, 3, and 4(b); an inner molding-engaging edge 32 as illustrated and referenced in FIGS. 1, 3, 4(a)-4(c), and 5; and at least one (i.e. if rounded), but preferably a plurality of outer free edges 33 (such as three edges 33 joined at right-angled corners) as generally referenced in FIGS. 1-6. It will be seen from an inspection of the noted figures that the inner molding-engaging edge 32 or edges 32 each preferably comprise a transverse, negatively-contoured molding profile 40 as referenced in FIGS. 3-6.

It will be understood from an inspection of FIGS. 1 and 3 that the floor-engaging surfaces 31 preferably comprise certain adhesive means 34 for enabling the user to removably and adhesively attach the masking tool(s) 10 to the floor surface 15. It is contemplated, that the adhesively attached masking tools 10, being adhesively fixed in complementary alignment with the molding elements 13, may be otherwise prevented from displacement from the complementary alignment 91 as generally depicted in FIG. 6. The adhesive means may thus function to enhance the complementary alignment so that material such as paint or spray paint 50 may not otherwise contact floor surface via gaps intermediate edge(s) 32 and molding elements 13. The adhesive means may be preferably covered with certain peel-away, adhesive-covering means such as a paper-based or similar other backing material 35 as illustrated and referenced in FIGS. 1 and 3. It is contemplated that the adhesive-covering means of the present invention may effectively function to enable the user to selectively expose the adhesive means 34 for adhesively attaching the masking tool(s) to the floor surface 15.

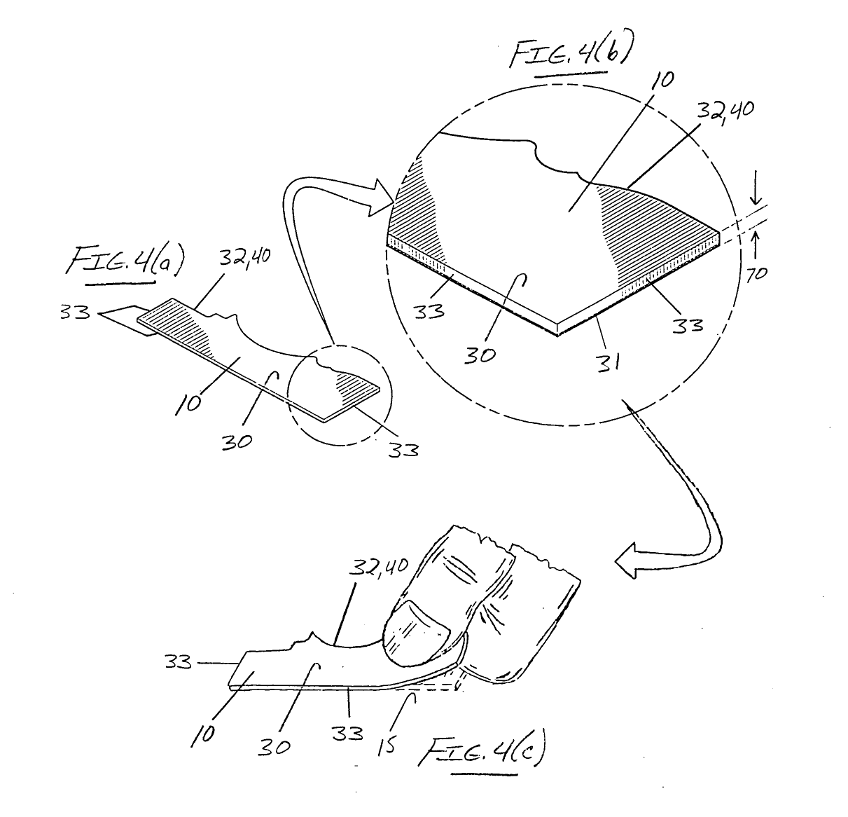

Further, the adhesive-covering means enable the user or the manufacturer stack and package a plurality of masking tools as generally depicted in FIG. 3 at 60. Thus, the masking tools may be preferably defined as being stackable, in part, for conserving pre-consumption packaging space as generally further depicted in FIG. 3. It will be further seen from an inspection of FIG. 4(b) as well as from a consideration of other noted figures that each masking tool comprises a substantially uniform tool thickness 70. The tool thickness, it is further contemplated may be incorporated into the design of masking tool 10 in order to enable the user to manually (in other words, with one's hand and/or fingers) remove each masking tool 10 from adhesive-engagement with the floor surface 15 after use as generally depicted in FIG. 4(c).

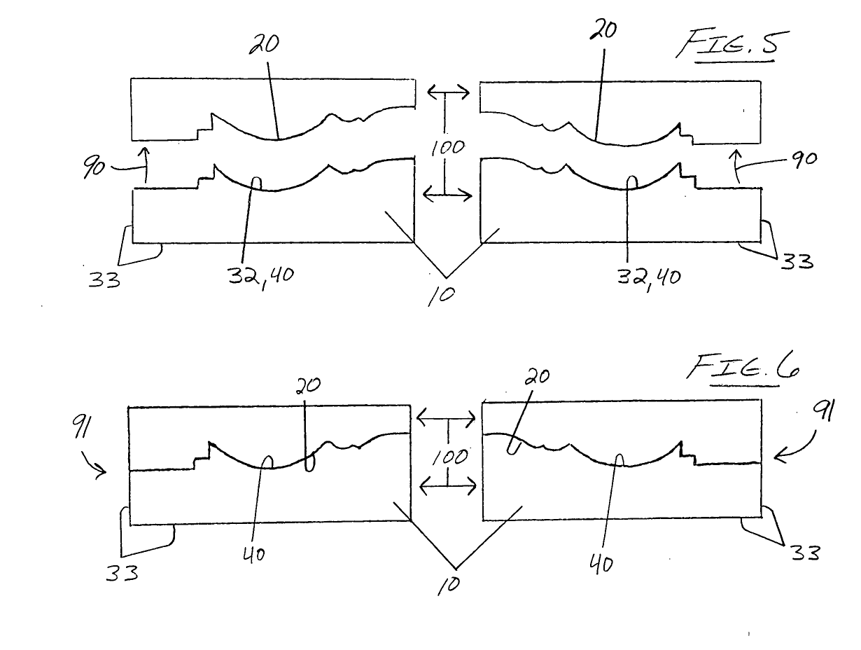

It will be further seen from an inspection of the noted figures that the positively-contoured molding profile or profiles 20 and negatively-contoured molding profile or profiles 40 are complementarily (i.e. snugly) alignable as generally depicted at 90 in FIG. 5. From a comparative inspection of FIG. 5 versus FIG. 6, the profile or profiles 20 complement or snugly match the profile or profiles 40. In other words, the negative profiles 40 are negatively configures relative to the positive profiles 20, although the structural relationship could very well also be described by stating that the positive profiles 20 are negatively configured relative to the negative profiles 40. The key notion being here addressed is that edge(s) 32 of the masking tool(s) 10 are configured so as to properly complement the transverse profile of the molding or similar other structure so that when matter is applied to the molding, the matter may not penetrate gaps intermediate the edge(s) 32 and the molding or molding profile 20, and thus prevent the matter from contacting or otherwise detracting from the floor surface 15 or similar other surface as generally depicted in FIG. 3.

Further, it will be seen from a comparative inspection of FIG. 5 and FIG. 6 that the complementarily aligned molding profiles 20 and 40 at the boundary of the paired tool-to-molding elements have laterally-opposite, left-to-right image or contour reversal as generally depicted and referenced at vector arrow(s) 100. While it is contemplated that the positively-contoured and negatively-contoured molding profiles 20 and 40 may be preferably defined by undulating, highly complex, or non-uniform profile contours, it is further contemplated that the contours may be more simplistic such as may be embodied by a uniformly arcuate transverse contour or profile. Although the configuration(s) available for the transverse molding profiles 20 are infinite, certain transverse molding profiles are more popular than others and thus the masking tool 10 of the present invention may be preformed to complement the molding profile 20 as demanded by the consumer.

Thus, the inner molding-engaging edges 32 may be complementarily aligned adjacent the molding elements 13, the floor-engaging surfaces 31 may engage the floor surface 15. Further, the molding elements 13 essentially function to laterally mask the doorway periphery 12 (as generally depicted in FIG. 1), the floor-masking surfaces 30 function to mask the floor surface 15 (adjacent the doorway periphery 12) from material applied (as for example, via spray-painting 50 or brush painting, or similar other activity) to the molding elements 13. The doorway-masking system of the present invention, as enabled by the masking tool 10 or masking tool kit 11 may properly function to mask the doorway periphery to enhance the visual appeal thereof.

As earlier presented, certain kit considerations are contemplated in connection with the present invention. In this regard, it is contemplated that masking tool kit 11 is essentially taught by the present invention insofar as the masking tools 10 may be plurally presented in stackable form as at 60 in a package 80 (as generally depicted and referenced in FIG. 3) in contour-reversed paired relation for complementing image-reversed or contour-reversed molding profiles 20 or similar other structural profiles as generally depicted in FIG. 1. The masking tool kit 11 may effectively function to enable a user to outfit structurally-adjacent surfaces such as floor surface 15 or other similar surfaces adjacent material-applicable structure as may be preferably defined by molding elements 13. The material-applicable structure essentially comprises a transverse, positively-contoured structural profile.

The masking tool kit 11 thus preferably comprises at least one, but preferably a plurality of masking tools 10, each of which essentially comprise a structure-engaging edge, such as edge 32 having a transverse, negatively-contoured structural profile. The positively-contoured and negatively-contoured structural profiles are complementarily alignable, and thus each structure-engaging edge is complementarily alignable adjacent the material-applicable structure. It is further contemplated that at least one set of paired masking tools 10 may be provided in the kit 11, the structural profiles of which set have opposing, contour-reversed profiles for complementarily aligning with contour-reversed structural profiles of paired structures such as may be preferably defined by molding elements 13.

While the above description contains much specificity, this specificity should not be construed as limitations on the scope of the invention, but rather as an exemplification of the invention. For example, the invention may be said to essentially disclose a masking tool, the masking tool for masking a surface adjacent a molding or similar other structure having a transverse, positively-contoured molding profile, and which masking tool comprises a molding- or structure-engaging edge. The molding- or structure-engaging edge comprises a transverse, negatively-contoured molding profile; the positively-contoured and negatively-contoured molding profiles being complementarily alignable. The molding-engaging edge is thus complementarily alignable adjacent the molding, and the masking tool thus functions to mask the to-be-protected or protectable surface from material applied to the target structure.

Accordingly, although the invention has been described by reference to a preferred embodiment, and a certain kit, it is not intended that the novel device or assembly be limited thereby, but that modifications thereof are intended to be included as falling within the broad scope and spirit of the foregoing disclosure, the following claims and the appended drawings.

We claim:

1. A doorway-masking system, the doorway-masking system for masking a doorway periphery, the doorway-masking system comprising, in combination:
a pair of doorway molding elements, the molding elements being laterally-aligned adjacent a doorway in superior adjacency to a floor surface, each molding element comprising a transverse, positively-contoured molding profile; and
a pair of masking tools, each masking tool comprising a first floor-masking surface, a second floor-engaging surface, and an inner molding-engaging edge, the molding-engaging edges each comprising a transverse, negatively-contoured molding profile, the positively-contoured and negatively-contoured molding profiles being complementarily alignable, the molding-engaging edges being complementarily aligned adjacent the molding elements, the floor-engaging surfaces engaging the floor surface, the molding elements for laterally masking the doorway periphery, the floor-masking surfaces for masking the floor surface from material applied to the molding elements, the doorway-masking system thus for masking the doorway periphery.

2. The doorway-masking system of claim 1 wherein the complementarily aligned molding profiles of paired tool-to-molding elements have laterally-opposite, left-to-right contour reversal.

3. The doorway-masking system of claim 1 wherein the positively-contoured and negatively-contoured molding profiles are defined by undulating profile contours.

4. The doorway-masking system of claim 1 wherein the floor-engaging surfaces comprise adhesive means, the adhesive means for enabling the user to removably and adhesively attach the masking tools to the floor surface, the adhesively attached masking tools thereby being adhesively fixed in complementary alignment with the molding elements.

5. The doorway-masking system of claim 4 comprising peel-away, adhesive-covering means, the adhesive-covering means for enabling the user to selectively expose the adhesive means for adhesively attaching the masking tools to the floor surface.

6. The doorway-masking system of claim 5 wherein the masking tools are stackable, the stackable masking tools for conserving pre-consumption packaging space.

7. The doorway-masking system of claim 6 wherein each masking tool comprises a substantially uniform tool thickness, the tool thickness for enabling a user to manually remove each masking tool from adhesive-engagement with the floor surface after use.

8. A masking tool, the masking tool for masking a protectable surface adjacent target structure, the target structure comprising a transverse, positively-contoured structural profile, the masking tool comprising a structure-engaging edge, the structure-engaging edge comprising a transverse, negatively-contoured structural profile, the positively-contoured and negatively-contoured structural profiles being complementarily alignable, the structure-engaging edge thus being complementarily alignable adjacent the target structure, the masking tool for masking the protectable surface from material applied to the target structure.

9. The masking tool of claim 8 usable in pairs, the paired masking tools being alignable adjacent paired target structures, the complementarily alignable structural profiles having paired, laterally-opposing, left-to-right contour reversal.

10. The masking tool of claim 8 wherein the negatively-contoured molding profile is complementarily alignable adjacent an undulating positively-contoured structural profile.

11. The masking tool of claim 8 comprising a surface-engaging portion, the surface-engaging portion comprising adhesive means, the adhesive means for enabling the user to removably and adhesively attach the masking tool to the protectable surface, the adhesively attached masking tool thereby being adhesively fixed in complementary alignment with the target structure.

12. The masking tool of claim 11 comprising adhesive-covering means, the adhesive-covering means for enabling the user to selectively expose the adhesive means for adhesively attaching the masking tool to the protectable surface.

13. The masking tool of claim 8 wherein the masking tool is plurally stackable, the plurally stackable masking tools for conserving pre-consumption packaging space.

14. The masking tool of claim 8 comprising a tool thickness, the tool thickness for enabling a user to manually remove the masking tool from engagement with the protectable surface after use.

15. A masking tool kit, the masking tool kit for enabling a user to outfit structurally-adjacent surfaces, the structurally-adjacent surfaces being adjacent material-applicable structure, the material-applicable structure comprising a transverse, positively-contoured structural profile, the masking tool kit comprising at least one masking tool, the masking tool comprising a structure-engaging edge, the structure-engaging edge comprising a transverse, negatively-contoured structural profile, the positively-contoured and negatively-contoured structural profiles being complementarily alignable, each structure-engaging edge thus being complementarily alignable adjacent the material-applicable structure, the masking tool kit thus enabling the user to outfit structurally-adjacent surfaces from material applied to the structure.

16. The masking tool kit of claim 15 comprising at least one set of paired masking tools, the structural profiles of each paired masking tool set having opposing, contour-reversed profiles, the contour-reversed profiles for complementarily aligning with contour-reversed structural profiles of paired structures.

17. The masking tool kit of claim 15 wherein each negatively-contoured structural profile is complementarily alignable adjacent an undulating positively-contoured structural profile.

18. The masking tool kit of claim 15 wherein each masking tool comprises a surface-engaging portion, each surface-engaging portion comprising adhesive means, the adhesive means for enabling the user to removably and adhesively attach each masking tool to the structurally-adjacent surface, each adhesively attachable masking tool thereby being adhesively fixable in complementary alignment with the material-applicable structure.

19. The masking tool kit of claim 18 wherein the adhesive means are covered with adhesive-covering means, the adhesive-covering means for enabling the user to selectively expose the adhesive means for adhesively attaching each masking tool to the structurally-adjacent surface.

20. The masking tool kit of claim 15 comprising plurally stackable masking tools, the plurally stackable masking tools for conserving pre-consumption packaging space.
